(19) United States
(12) Patent Application Publication
(10) Pub. No.: US 2016/0078520 A1
(43) Pub. Date: Mar. 17, 2016

(54) MODIFIED MATRIX FACTORIZATION OF CONTENT-BASED MODEL FOR RECOMMENDATION SYSTEM

(71) Applicant: Microsoft Corporation, Redmond, WA (US)

(72) Inventors: Nir Nice, Kfar Veradim (IL); Noam Koenigstein, Ra'anana (IL); Shahar Keren, Hemed (IL); Ayelet Kroskin, Tel Aviv (IL); Ulrich Paquet, Cambridge (GB)

(21) Appl. No.: 14/484,981

(22) Filed: Sep. 12, 2014

(51) Int. Cl. G06Q 30/06

(52) U.S. Cl. CPC G06Q 30/0631

(57) ABSTRACT

A recommendation system is implemented using modified matrix factorization on top of a content-based matrix to provide both user-to-item and item-to-item content-based recommendations while exposing the full depth of transitive relationships among recommendations. Content information such as features and characteristics may be represented in a usage matrix in which features are treated as users would be in traditional matrix factorization. Matrix factorization is applied to the “features-as-users” matrix to build a content-based model in which features and items are embedded in a low dimension latent space. User history is employed for system training by locating user vectors within the latent space. Recommendations that are near to the vector can be provided to the users along with explanations (e.g., a recommendation is given because of an item's proximity to a particular feature).

### BACKGROUND

Recommendation systems using collaborative filtering are generally viewed to outperform content-based systems when there is an appropriate amount of data available such as usage and rating data. However, content-based recommendation systems can bring significant improvements compared to collaborative filtering in cases where there is limited data available such as in the case with “cold” users and items, live events, news, etc. Collaborative filtering can also be less performant in cases where users are seeking recommendation diversification for items that are based, for example, on some logical relationship such as the same actor and genre for movie items. In addition, because collaborative filtering recommendations are typically based on a usage model that comprises a set of users who liked items and who are in the user's network (i.e., share similar behaviors, are friends with user, etc.), explanations are inherently limited as to the reasons a particular item is recommended to a user.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A recommendation system is implemented using modified matrix factorization on top of a content-based matrix to determine both user-to-item and item-to-item content-based recommendations while exposing the full depth of transitive relationships among recommendations. Content information such as features and characteristics may be represented in a usage matrix in which features are treated as users would be in traditional usage matrix factorization. Matrix factorization is applied to this “features-as-users” matrix to build a content-based item model in which items are embedded in a low dimension latent space. User history is factorized using the item model to generate a user model that is employed for system training. By locating user vectors within the latent space, recommendations that are near to the vector can be provided to the users along with explanations (e.g., a recommendation is given because of an item's proximity to a particular feature).

In various illustrative examples, weighting can be applied when building the features-as-users matrix to give a particular feature/characteristic more relative weight when it is more dominating. For example, with movie features, the movie's genre can be given more weight than the movie's location or setting. A usage model (e.g., one created using conventional collaborative filtering) may be combined with a content-based model to create a parallel system in which selection logic may be applied to provide recommendations from one model or the other based on context and/or other factors. Explanations from the content-based model can also be applied to recommendations from the usage-based model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative environment in which devices having communications capabilities interact over a network;

FIG. 2 shows illustrative interactions between a recommendation service and a recommendation client that is instantiated on a device;

FIG. 3 shows a graphic depiction of an illustrative dataset in which users are mapped to items;

FIG. 4 shows that a given recommendation may have an associated explanation;

FIG. 5 is a flowchart of an illustrative method for implementing the present modified matrix factorization of a content-based model;

FIG. 6 shows an illustrative regular usage matrix;

FIG. 7 shows an illustrative features-as-users matrix;

FIG. 8 is a functional block diagram of an illustrative recommendation system;

FIG. 9 is a simplified block diagram of an illustrative computer system such as a personal computer (PC) that may be used in part to implement the present modified matrix factorization of a content-based model;

FIG. 10 shows a block diagram of an illustrative device that may be used in part to implement the present modified matrix factorization of a content-based model;

FIG. 11 is a block diagram of an illustrative multimedia console.

Like reference numerals indicate like elements in the drawings. Elements are not drawn to scale unless otherwise indicated.

### DETAILED DESCRIPTION

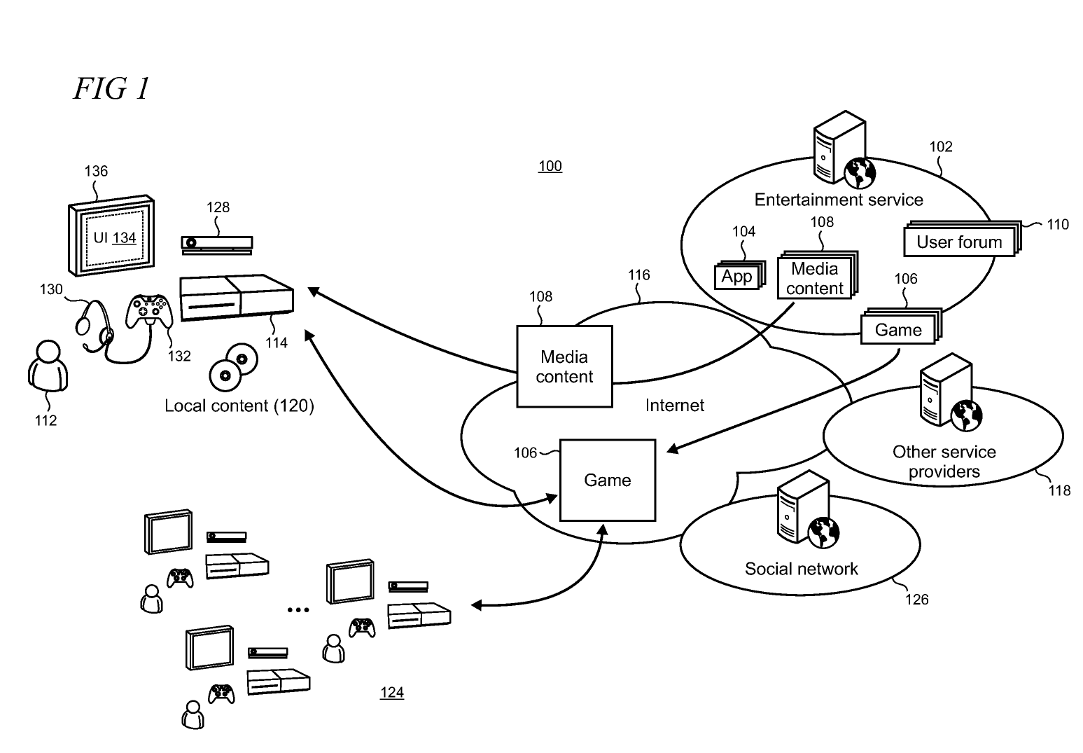

FIG. 1 shows an illustrative computing environment 100 in which the present recommendation system may be implemented. An entertainment service 102 typically can expose applications (“apps”) 104, games 106, media content 108 such as television shows and movies, and user forums 110 to a user 112 of a multimedia console 114 over a network such as the Internet 116. Other service providers 118 may also be in the environment 100 that can provide various other services such as communication services, financial services, travel services, news and information services, etc. In some implementations, the features, capabilities, and functionalities provided by the multimedia console 114 can be replaced by those supported on other types of computing platforms such as personal computers (PCs), laptop computers, and the like.

Local content 120, including apps, games, and/or media content may also be utilized and/or consumed in order to provide a particular user experience in the environment 100. In some cases the local content 120 is obtained from removable sources such as optical discs including DVDs (Digital Versatile Discs) and CDs (Compact Discs) while in others, the local content is downloaded from a remote source and saved locally. Games, content, apps, and other user experiences may execute locally on the multimedia console 114, be hosted remotely by the entertainment service 102, or use a combination of local and remote execution in some cases using local or networked content/apps/games as appropriate. User experiences can be shared in some cases. For example, a game 106 may be one in which multiple other players 124 with other computing devices can participate. In some implementations, a user experience can also be shared on a social network 126.

The user 112 can typically interact with the multimedia console 114 using a variety of different interface devices including a camera system 128 that can be used to sense visual commands, motions, and gestures, and a headset 130 or other type of microphone or audio capture device/system. In some cases a microphone and camera can be combined into a single device. The user 112 may also utilize a controller 132 to interact with the multimedia console 114. The controller 132 may include a variety of physical controls including joysticks, a directional pad (D-pad), and buttons. One or more triggers and/or bumpers (not shown) may also be incorporated into the controller 132. The user 112 will typically interact with a user interface (UI) 134 that is shown on a display device 136 such as a television or monitor. It is emphasized that the number of controls utilized and the features and functionalities supported by the user controls implemented in the camera system 128, audio capture system, and controller 132 can vary from what is shown in FIG. 1 according to the needs of a particular implementation. As used here, the term “system” encompasses the various software (including the software operating system (OS) and applications), hardware, and firmware components that are instantiated on the multimedia console and its peripheral devices and/or components that are instantiated by the recommendation system and entertainment service in support of various user experiences described herein.

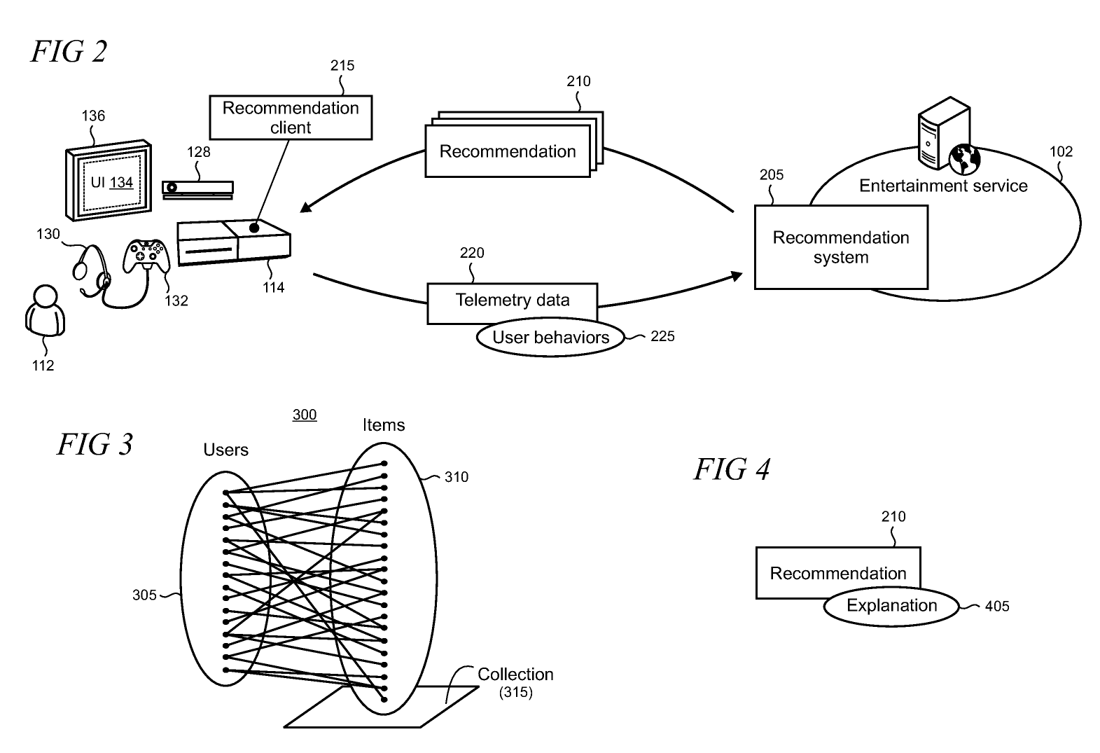

As shown in FIG. 2, in this illustrative example the entertainment service 102 includes a recommendation system 205 that generates recommendations 210 that are provided to a client 215 operating on the multimedia console 114 which, in turn, can expose the recommendations to the user 112 through the UI 134. While a multimedia console 114 is used in this particular example, it is emphasized that other computing platforms such as PCs, tablets, smartphones, etc. may be utilized in other recommendation system implementations. The recommendation client 215 can capture telemetry data 220 at the multimedia console 114 (typically upon notice to the user 112 and with the user's consent) that describes user behavior 225 when interacting with the console and/or other elements in the environment 100 (FIG. 1).

The recommendations 210 can vary by context and implementation but generally will relate to various apps, games, media content, and other content/experiences that the user 112 may wish to consider for present or future consumption. The recommendations can be surfaced in response to user queries seeking recommended content in some cases, or be surfaced opportunistically when the system determines from the attendant circumstances that the user could benefit from receiving recommendations. In some implementations, the various controls can be implemented to enable the user to control how and when recommendations are provided (e.g., user preferences, etc.) as well as provide feedback as to the appropriateness of recommendations that can be utilized for system and/or dataset tuning and improvements.

The telemetry data 220 may be populated into a dataset 300 that may be utilized by the recommendation system 205 as represented in FIG. 3 where a constellation of users 305 is mapped to a constellation of items 310 that are associated in a collection 315. The collection could be exposed, for example, as part of services provided by the entertainment service. The mapping can indicate usage or consumption of particular items by users and the dataset can also include user ratings and item characteristics in some cases. Typically, the constellation of items is larger than the constellation of users (i.e., there are more items than users).

A recommendation 210 may be further associated with a corresponding explanation 405 as shown in FIG. 4. That is, unlike typical systems employing collaborative filtering, the present recommendation system can provide reasons behind why a particular item is recommended to a particular user. The explanations 405 can typically be expected to enhance user experiences with the recommendation system 205 by encouraging interaction, broadening opportunities for discovering new items, enabling wrong impressions of the recommendation to be corrected, and improving recommendation accuracy. Such benefits can be significant given that users can often be inundated with choices.

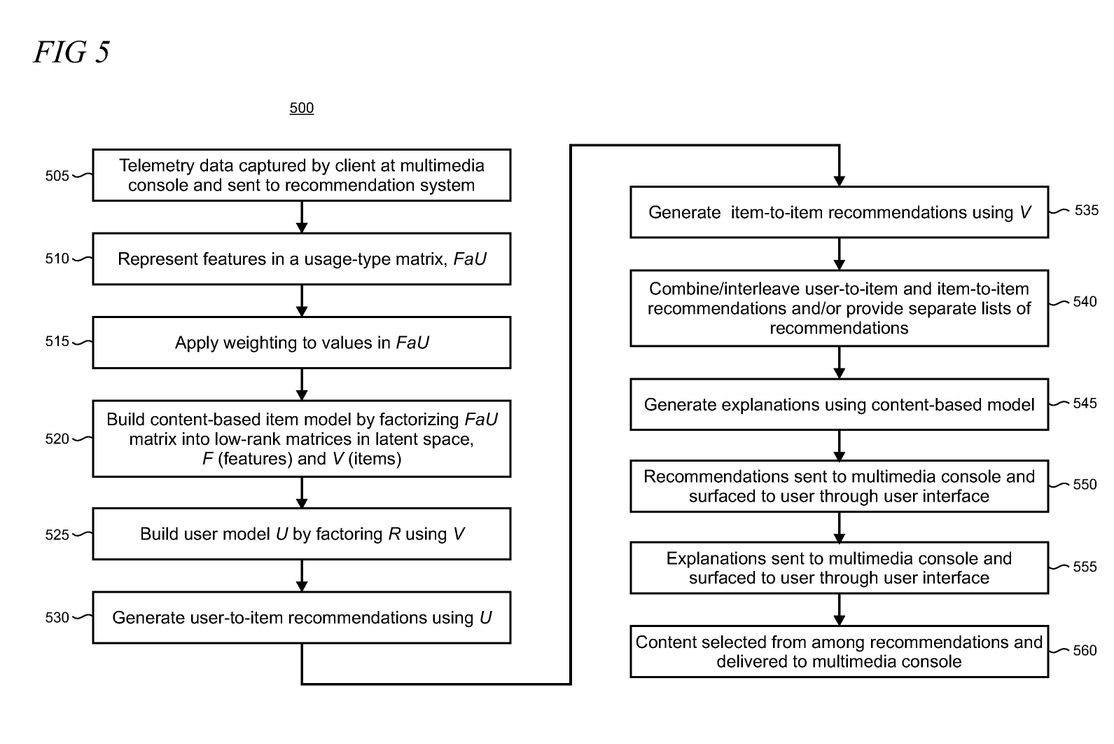

FIG. 5 is a flowchart of an illustrative method 500 for implementing the present modified matrix factorization of a content-based model. Unless specifically stated, the methods or steps shown in the flowchart are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

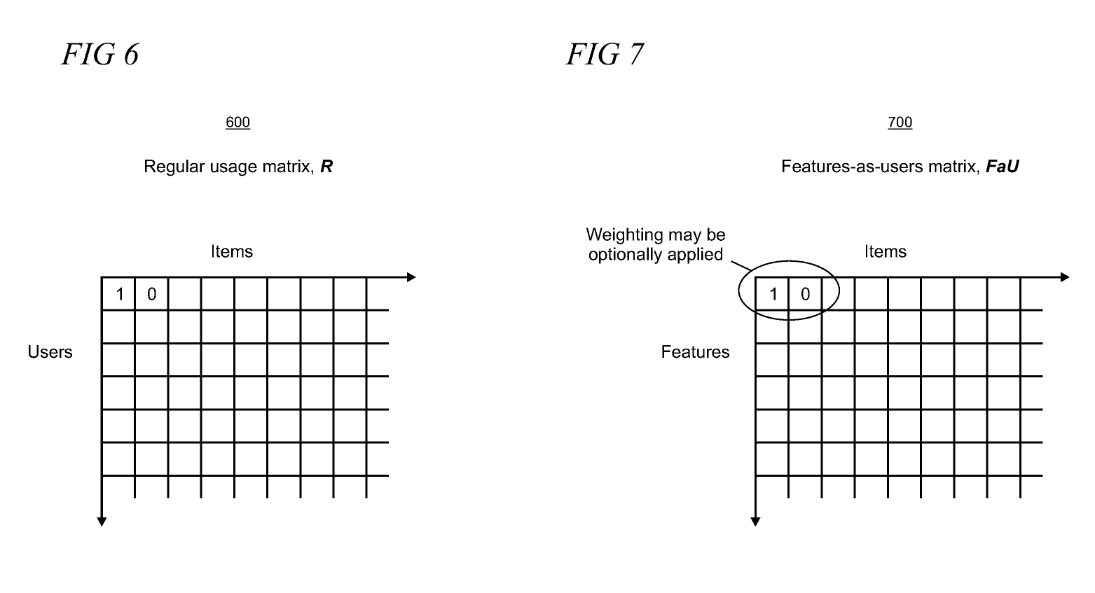

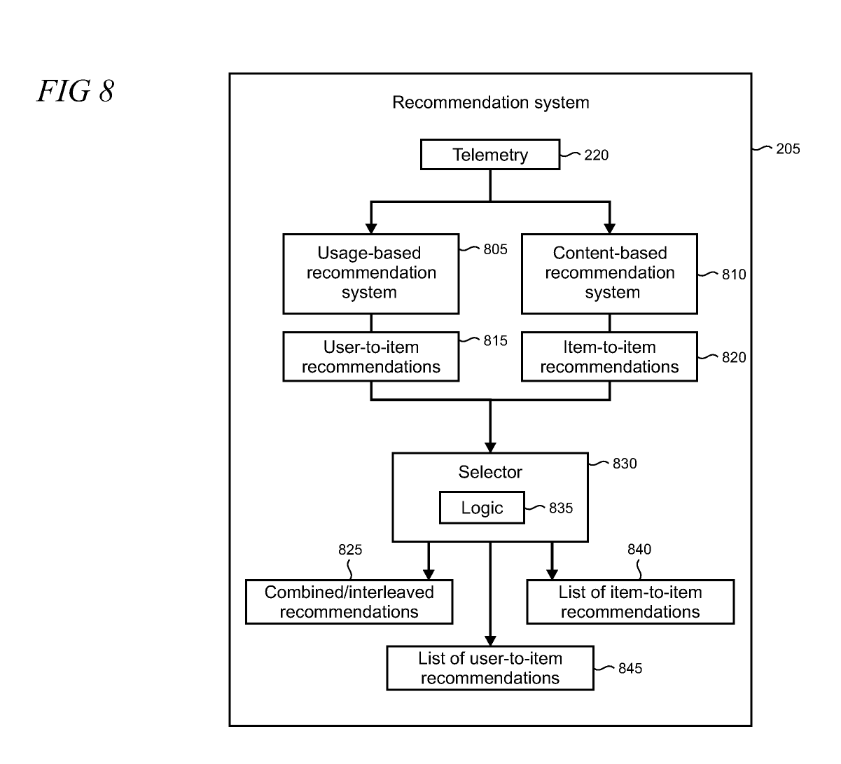

In step 505, the telemetry data 220 (FIG. 2) representing user behaviors 225 is captured by the recommendation client 215 and sent over a network to the recommendation system 205. In step 510, the recommendation system employs the results of modified matrix factorization in which features associated with items are represented in a usage-type matrix, termed here as a “Features-as-Users” matrix, or FaU. The FaU may be compared to a regular usage matrix R in which users are represented in rows and items are represented as columns, as shown in the illustrative matrix R in FIG. 6, as indicated by reference numeral 600. The FaU substitutes features in the rows that normally represent users in the regular usage matrix, as shown in the illustrative FaU matrix in FIG. 7, as indicated by reference numeral 700. As shown in FIG. 7 and in step 515 in the flowchart of FIG. 5, weighting may be optionally applied as described in more detail below.

The FaU may be represented mathematically as

$$FaU = [ \begin{matrix}{C}_{11} & … & {C}_{1 M} \\ ⋮ & ⋱ & ⋮ \\ {C}_{N 1} & … & {C}_{NM}\end{matrix} ]$$

such that the value of cell Cᵢⱼ is determined as:

$${C}_{ij} = \{ \begin{matrix}1 & if item j exhibits features i \\ 0 & otherwise\end{matrix}$$

Returning to the flowchart in FIG. 5, in step 520 a content-based item model is built by factorizing the FaU matrix into two low ranked matrices in the latent space—F, representing the features-as-users and V, representing items such that

F*V^{T}=FaU

Matrix F is composed of K rows which are vectors in a d-dimensional latent space. The vector in row i is marked by fᵢεR^{d}, and holds the low dimensional latent representation of the feature i. The dimensionality (d) is usually low (e.g., d=50). Matrix V is composed of N rows which are vectors in a d-dimensional latent space. The vector in row j is marked by vⱼεR^{d}, and holds the low dimensional latent representation of the an item j. The dimensionality (d) is usually low (e.g., d=50).

Given a dataset of binary item-feature relations

$$FaU = {\{ {c}_{ij} \}}_{i = 1 , j = 1}^{i = K , j = N} ,$$

the probability of cᵢⱼ=1 is modeled by

Pr(cᵢⱼ=1|fᵢ,vⱼ)=(σ(fᵢ′vⱼ;w))^{r}(1−σ(fᵢ′vⱼ;w))^{1-r}

where σ(x; s) is a logistic function with a weight or strength s as follows:

$$σ ( x ; s ) = \frac{{e}^{- 2 sz}}{\frac{1}{2 s} {( 1 + {e}^{- 2 sz} )}^{2}}$$

The overall likelihood of the model is simply

Π_{c}_{ᵢⱼ}_{εFaU}Pr(cᵢⱼ=1|fᵢ,vⱼ).

Adding Gaussian priors on all the parameters, the posterior may be written down and any feasible inference methods may be used to learn the parameters. In this particular illustrative example, variational Bayes inference is utilized to approximate the posterior on the parameters.

It may be appreciated that the processes used to build the content-based item model have some similarities to conventional collaborative filtering matrix factorization. In terms of the modeling, however, there are two main differences between this factorization and a typical usage based system: First, with the content-based item model, the entire FaU matrix is factorized, while in a usage-based system, the negative examples (zeros cells) may typically be sampled. Second, with the content-based item model, different weights may be given to positive and negative examples compared to a usage-based system where all examples are typically given an identical weight value of ‘1’. The positive examples in the present model may receive the standard weight value of ‘1’, but for the negative values, a different weight may be utilized which is typically lower and selected using cross validation.

The learned matrix V is the content-based item model. It can be used to train users or to compute item-to-item relations.

In step 525 in FIG. 5, a user model U is built by using the content-based item model V to factorize the regular usage matrix R such that

U*V^{T}=R.

In step 530, user-to-item recommendations may be generated using the user model U, and item-to-item recommendations may be generated using the content-based item model V in step 535. The recommendation generation in steps 530 and 535 can be implemented in a similar manner as with conventional matrix factorization-based recommendation systems.

In step 540, different recommendations using the different models can be combined and/or interleaved in some manner. For example, usage-based recommendations may vary from content-based recommendations. With the former, recommendations may lean towards traditional collaborative results, while with the latter, recommendations may lean more towards features. The combining and interleaving may be performed in some implementations using the recommendation system as configured as shown in FIG. 8. Here, the telemetry data 220 is utilized by two recommendation subsystems: a usage-based recommendation subsystem 805 and a content-based recommendation subsystem 810. A selector 830, applying selection logic 835, combines and/or interleaves the generated user-to-item recommendations 815 and item-to-item recommendations 820 into a group 825 or sorts them by type into separate lists 840 and 845.

Returning again to FIG. 5, in step 545 explanations are generated using the content-based item model V. The recommendations and explanations may be sent to the multimedia console and surfaced through its UI to the user in respective steps 550 and 555. In typical implementations, the user can pick from among recommendations to have recommended content delivered to the multimedia console from the entertainment service, as indicated in step 560.

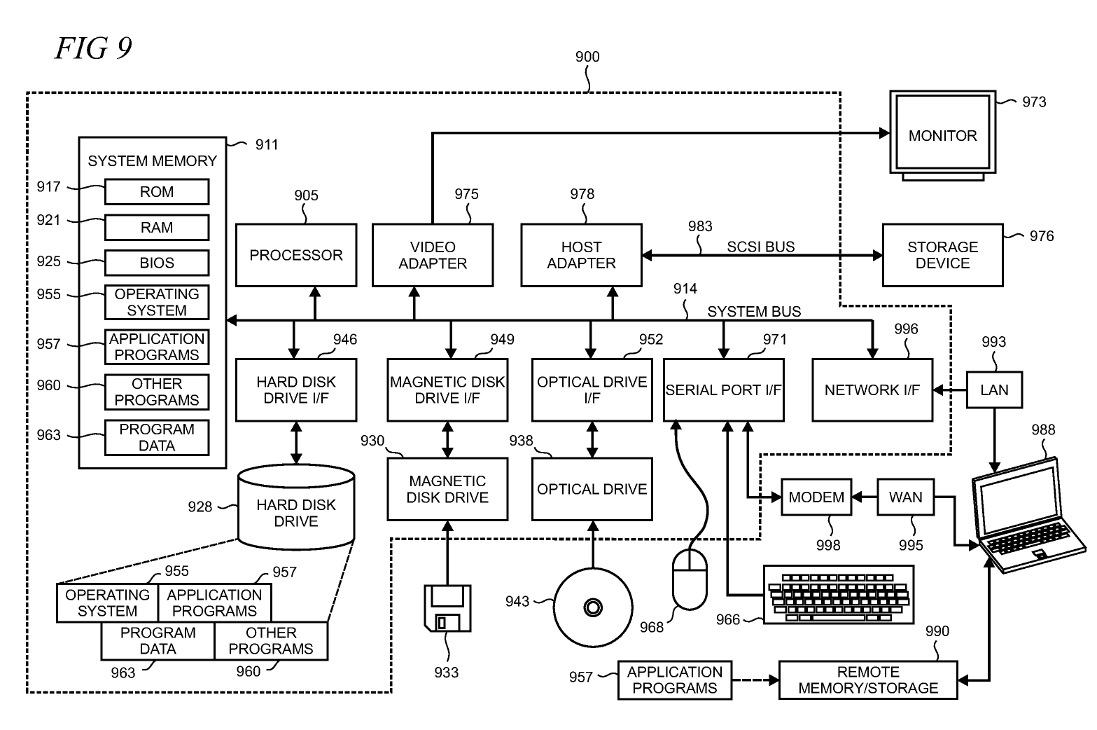

FIG. 9 is a simplified block diagram of an illustrative computer system 900 such as a PC, client machine, or server with which the present modified matrix factorization of a content-based model may be implemented. Computer system 900 includes a processor 905, a system memory 911, and a system bus 914 that couples various system components including the system memory 911 to the processor 905. The system bus 914 may be any of several types of bus structures including a memory bus or memory controller, a peripheral bus, or a local bus using any of a variety of bus architectures. The system memory 911 includes read only memory (ROM) 917 and random access memory (RAM) 921. A basic input/output system (BIOS) 925, containing the basic routines that help to transfer information between elements within the computer system 900, such as during startup, is stored in ROM 917. The computer system 900 may further include a hard disk drive 928 for reading from and writing to an internally disposed hard disk (not shown), a magnetic disk drive 930 for reading from or writing to a removable magnetic disk 933 (e.g., a floppy disk), and an optical disk drive 938 for reading from or writing to a removable optical disk 943 such as a CD (compact disc), DVD (digital versatile disc), or other optical media. The hard disk drive 928, magnetic disk drive 930, and optical disk drive 938 are connected to the system bus 914 by a hard disk drive interface 946, a magnetic disk drive interface 949, and an optical drive interface 952, respectively. The drives and their associated computer-readable storage media provide non-volatile storage of computer-readable instructions, data structures, program modules, and other data for the computer system 900. Although this illustrative example includes a hard disk, a removable magnetic disk 933, and a removable optical disk 943, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present modified matrix factorization of a content-based model. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 933, optical disk 943, ROM 917, or RAM 921, including an operating system 955, one or more application programs 957, other program modules 960, and program data 963. A user may enter commands and information into the computer system 900 through input devices such as a keyboard 966 and pointing device 968 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 905 through a serial port interface 971 that is coupled to the system bus 914, but may be connected by other interfaces, such as a parallel port, game port, or universal serial bus (USB). A monitor 973 or other type of display device is also connected to the system bus 914 via an interface, such as a video adapter 975. In addition to the monitor 973, personal computers typically include other peripheral output devices (not shown), such as speakers and printers. The illustrative example shown in FIG. 9 also includes a host adapter 978, a Small Computer System Interface (SCSI) bus 983, and an external storage device 976 connected to the SCSI bus 983.

The computer system 900 is operable in a networked environment using logical connections to one or more remote computers, such as a remote computer 988. The remote computer 988 may be selected as another personal computer, a server, a router, a network PC, a peer device, or other common network node, and typically includes many or all of the elements described above relative to the computer system 900, although only a single representative remote memory/storage device 990 is shown in FIG. 9. The logical connections depicted in FIG. 9 include a local area network (LAN) 993 and a wide area network (WAN) 995. Such networking environments are often deployed, for example, in offices, enterprise-wide computer networks, intranets, and the Internet.

When used in a LAN networking environment, the computer system 900 is connected to the local area network 993 through a network interface or adapter 996. When used in a WAN networking environment, the computer system 900 typically includes a broadband modem 998, network gateway, or other means for establishing communications over the wide area network 995, such as the Internet. The broadband modem 998, which may be internal or external, is connected to the system bus 914 via a serial port interface 971. In a networked environment, program modules related to the computer system 900, or portions thereof, may be stored in the remote memory storage device 990. It is noted that the network connections shown in FIG. 9 are illustrative and other means of establishing a communications link between the computers may be used depending on the specific requirements of an application of the present modified matrix factorization of a content-based model.

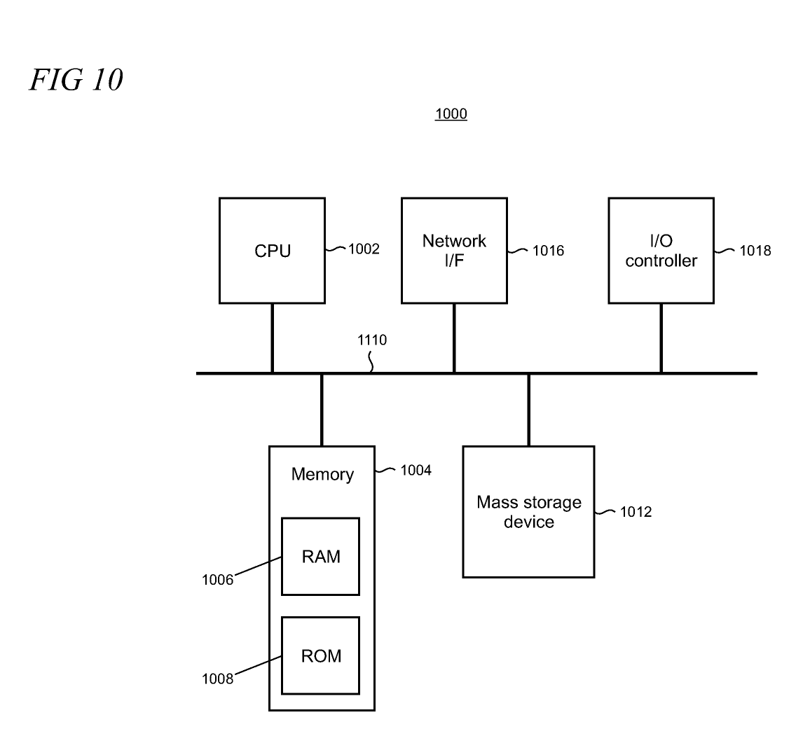

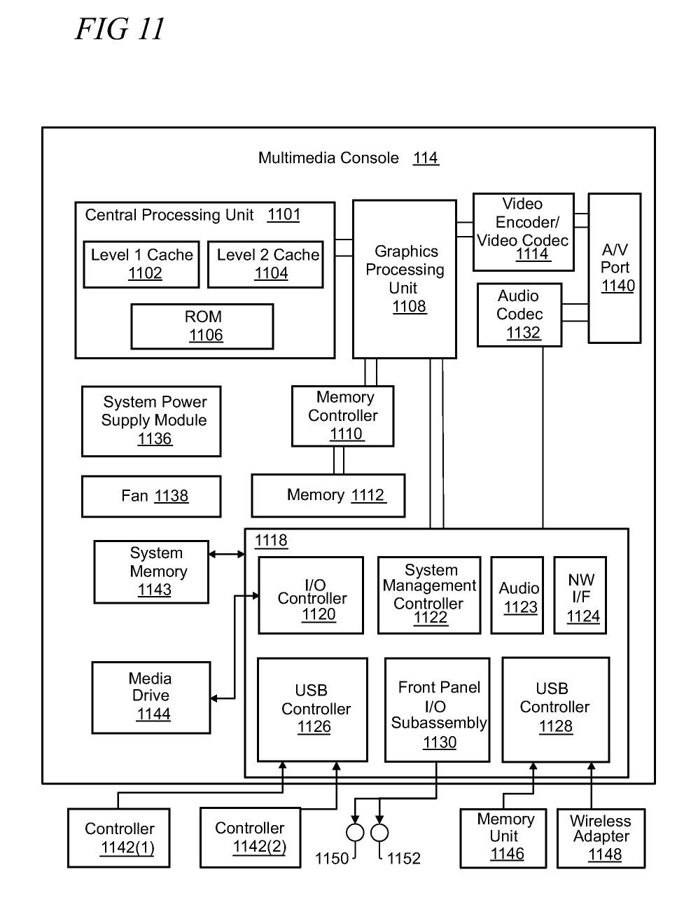

FIG. 10 shows an illustrative architecture 1000 for a device capable of executing the various components described herein for providing the present modified matrix factorization of a content-based model. Thus, the architecture 1000 illustrated in FIG. 10 shows an architecture that may be adapted for a server computer, mobile phone, a PDA, a smartphone, a desktop computer, a netbook computer, a tablet computer, GPS device, gaming console, and/or a laptop computer. The architecture 1000 may be utilized to execute any aspect of the components presented herein.

The architecture 1000 illustrated in FIG. 10 includes a CPU (Central Processing Unit) 1002, a system memory 1004, including a RAM 1006 and a ROM 1008, and a system bus 1010 that couples the memory 1004 to the CPU 1002. A basic input/output system containing the basic routines that help to transfer information between elements within the architecture 1000, such as during startup, is stored in the ROM 1008. The architecture 1000 further includes a mass storage device 1012 for storing software code or other computer-executed code that is utilized to implement applications, the file system, and the operating system.

The mass storage device 1012 is connected to the CPU 1002 through a mass storage controller (not shown) connected to the bus 1010. The mass storage device 1012 and its associated computer-readable storage media provide non-volatile storage for the architecture 1000.

Although the description of computer-readable storage media contained herein refers to a mass storage device, such as a hard disk or CD-ROM drive, it may be appreciated by those skilled in the art that computer-readable storage media can be any available storage media that can be accessed by the architecture 1000.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1000.

According to various embodiments, the architecture 1000 may operate in a networked environment using logical connections to remote computers through a network. The architecture 1000 may connect to the network through a network interface unit 1016 connected to the bus 1010. It may be appreciated that the network interface unit 1016 also may be utilized to connect to other types of networks and remote computer systems. The architecture 1000 also may include an input/output controller 1018 for receiving and processing input from a number of other devices, including a keyboard, mouse, or electronic stylus (not shown in FIG. 10). Similarly, the input/output controller 1018 may provide output to a display screen, a printer, or other type of output device (also not shown in FIG. 10).

It may be appreciated that the software components described herein may, when loaded into the CPU 1002 and executed, transform the CPU 1002 and the overall architecture 1000 from a general-purpose computing system into a special-purpose computing system customized to facilitate the functionality presented herein. The CPU 1002 may be constructed from any number of transistors or other discrete circuit elements, which may individually or collectively assume any number of states. More specifically, the CPU 1002 may operate as a finite-state machine, in response to executable instructions contained within the software modules disclosed herein. These computer-executable instructions may transform the CPU 1002 by specifying how the CPU 1002 transitions between states, thereby transforming the transistors or other discrete hardware elements constituting the CPU 1002.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1000 in order to store and execute the software components presented herein. It may also be appreciated that the architecture 1000 may include other types of computing devices, including handheld computers, embedded computer systems, smartphones, PDAs, and other types of computing devices known to those skilled in the art. It is also contemplated that the architecture 1000 may not include all of the components shown in FIG. 10, may include other components that are not explicitly shown in FIG. 10, or may utilize an architecture completely different from that shown in FIG. 10.

FIG. 11 is an illustrative functional block diagram of a multimedia console 114. The multimedia console 114 has a central processing unit (CPU) 1101 having a level 1 cache 1102, a level 2 cache 1104, and a Flash ROM (Read Only Memory) 1106. The level 1 cache 1102 and the level 2 cache 1104 temporarily store data and hence reduce the number of memory access cycles, thereby improving processing speed and throughput. The CPU 1101 may be configured with more than one core, and thus, additional level 1 and level 2 caches 1102 and 1104. The Flash ROM 1106 may store executable code that is loaded during an initial phase of a boot process when the multimedia console 114 is powered ON.

A graphics processing unit (GPU) 1108 and a video encoder/video codec (coder/decoder) 1114 form a video processing pipeline for high speed and high resolution graphics processing. Data is carried from the GPU 1108 to the video encoder/video codec 1114 via a bus. The video processing pipeline outputs data to an A/V (audio/video) port 1140 for transmission to a television or other display. A memory controller 1110 is connected to the GPU 1108 to facilitate processor access to various types of memory 1112, such as, but not limited to, a RAM.

The multimedia console 114 includes an I/O controller 1120, a system management controller 1122, an audio processing unit 1123, a network interface controller 1124, a first USB (Universal Serial Bus) host controller 1126, a second USB controller 1128, and a front panel I/O subassembly 1130 that are preferably implemented on a module 1118. The USB controllers 1126 and 1128 serve as hosts for peripheral controllers 1142(1) and 1142(2), a wireless adapter 1148, and an external memory device 1146 (e.g., Flash memory, external CD/DVD ROM drive, removable media, etc.). The network interface controller 1124 and/or wireless adapter 1148 provide access to a network (e.g., the Internet, home network, etc.) and may be any of a wide variety of various wired or wireless adapter components including an Ethernet card, a modem, a Bluetooth module, a cable modem, or the like.

System memory 1143 is provided to store application data that is loaded during the boot process. A media drive 1144 is provided and may comprise a DVD/CD drive, hard drive, or other removable media drive, etc. The media drive 1144 may be internal or external to the multimedia console 114. Application data may be accessed via the media drive 1144 for execution, playback, etc. by the multimedia console 114. The media drive 1144 is connected to the I/O controller 1120 via a bus, such as a Serial ATA bus or other high speed connection (e.g., IEEE 1394).

The system management controller 1122 provides a variety of service functions related to assuring availability of the multimedia console 114. The audio processing unit 1123 and an audio codec 1132 form a corresponding audio processing pipeline with high fidelity and stereo processing. Audio data is carried between the audio processing unit 1123 and the audio codec 1132 via a communication link. The audio processing pipeline outputs data to the A/V port 1140 for reproduction by an external audio player or device having audio capabilities.

The front panel I/O subassembly 1130 supports the functionality of the power button 1150 and the eject button 1152, as well as any LEDs (light emitting diodes) or other indicators exposed on the outer surface of the multimedia console 114. A system power supply module 1136 provides power to the components of the multimedia console 114. A fan 1138 cools the circuitry within the multimedia console 114.

The CPU 1101, GPU 1108, memory controller 1110, and various other components within the multimedia console 114 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 114 is powered ON, application data may be loaded from the system memory 1143 into memory 1112 and/or caches 1102 and 1104 and executed on the CPU 1101. The application may present a graphical user interface that provides a consistent user experience when navigating to different media types available on the multimedia console 114. In operation, applications and/or other media contained within the media drive 1144 may be launched or played from the media drive 1144 to provide additional functionalities to the multimedia console 114.

The multimedia console 114 may be operated as a standalone system by simply connecting the system to a television or other display. In this standalone mode, the multimedia console 114 allows one or more users to interact with the system, watch movies, or listen to music. However, with the integration of broadband connectivity made available through the network interface controller 1124 or the wireless adapter 1148, the multimedia console 114 may further be operated as a participant in a larger network community.

When the multimedia console 114 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 114 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 1101 at predetermined times and intervals in order to provide a consistent system resource view to the application. The scheduling arranged is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 1142(1) and 1142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Based on the foregoing, it may be appreciated that technologies for modified matrix factorization of a content-based model have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and may not be construed as limiting. Various modifications and changes may be made to the subject matter described herein without following the example embodiments and applications illustrated and described, and without departing from the true spirit and scope of the present modified matrix factorization of a content-based model, which is set forth in the following claims.

What is claimed:

1. One or more computer-readable memories storing instructions which, when executed by one or more processors disposed in a computing device having communications capabilities over a network, implement a method for providing a recommendation system, comprising:
capturing telemetry data representing user interaction with a collection of items; and
receiving an item-to-item recommendation, the recommendation being generated by applying modified matrix factorization to a matrix in which columns in the matrix represent content items and rows in the matrix represent content features to generate a content-based item model in a latent space and training user vectors in the latent space to identify a nearby content feature, the user vectors being generated using the telemetry data.

2. The one or more computer-readable memories of claim 1 further including receiving a user-to-item recommendation and surfacing either the user-to-item recommendation or the item-to-item recommendation to the user of the computing device, the user-to-item recommendation be generated using a user model that is generated by factorizing a usage model with the content-based item model.

3. The one or more computer-readable memories of claim 2 in which the usage model is generated using the captured telemetry data.

4. The one or more computer-readable memories of claim 1 in which the matrix of content features and content items includes one or more weighted values.

5. The one or more computer-readable memories of claim 4 in which the weighted values include positive values and negative values, the negative values being selected using cross validation.

6. The one or more computer-readable memories of claim 1 in which the matrix is a features-as-users matrix.

7. The one or more computer-readable memories of claim 1 further including receiving an explanation that is associated with a given recommendation and surfacing the explanation to the user of the computing device.

8. The one or more computer-readable memories of claim 1 further including receiving one of a list of user-to-item recommendations, a list of item-to-item recommendations, or a combined group of user-to-item recommendations and item-to-item recommendations.

9. The one or more computer-readable memories of claim 1 in which the modified matrix factorization comprises variational Bayes matrix factorization.

10. The one or more computer-readable memories of claim 1 in which a recommendation takes into account a transitive relationship depth between items in the latent space.

11. A system, comprising:
one or more processors;
a memory storing computer-readable instructions which, when executed by the one or more processors, perform a method for generating recommendations, the method comprising the steps of
receiving telemetry data captured by a population of devices, the telemetry data representing behavior of respective users of the devices with respect to features of items in a collection,
representing the captured telemetry data in a features-as-users matrix,
factorizing the features-as-users matrix to generate first and second low rank latent space matrices, the first low rank latent space matrix representing the features and the second low rank latent space matrix representing a content-based item model,
building a user model by factorizing a usage model with the content-based item model, and
generating an item-to-item recommendation utilizing the content-based item model.

12. The system of claim 11 further including generating a user-to-item recommendation using the user model.

13. The system of claim 11 further including generating an explanation using the content-based item model.

14. The system of claim 13 in which the explanation is applied to either the item-to-item recommendation or the user-to-item recommendation.

15. The system of claim 14 further sending content to a device, the content being user-selected based on a recommendation.

16. The system of claim 11 in which the factorizing of the features-as-users matrix is performed using a variational Bayes inference.

17. A method for generating recommendations for items in collection electronically accessible by users of respective computing devices, the method comprising the steps of:
representing item features in a matrix as if the features are users in a user-to-item usage matrix;
building a content-based item model in which items are embedded in a low dimension latent space by factorizing the matrix; and
generating recommendations by training users with the latent space.

18. The method of claim 17 further including generating a user-to-item recommendation.

19. The method of claim 17 further including generating an item-to-item recommendation.

20. The method of claim 17 further generating explanations that correspond to respective generated recommendations.
